(19) United States
(12) Patent Application Publication
(10) Pub. No.: US 2025/0038175 A1
(43) Pub. Date: Jan. 30, 2025

(54) ELECTRODE COMPOSITE MATERIAL, LITHIUM-ION BATTERY, AND PRODUCTION METHOD FOR LITHIUM-ION BATTERY

(71) Applicant: TOYOTA JIDOSHA KABUSHIKI KAISHA, Toyota-shi (JP)

(72) Inventors: Mitsutoshi OTAKI, Susono-shi (JP); Jun YOSHIDA, Mishima-shi (JP); Masafumi NOSE, Mishima-shi (JP); Yasuhiro YAMAGUCHI, Kariya-shi (JP); Tatsuya EGUCHI, Kariya-shi (JP); Masanori HARATA, Kariya-shi (JP); Tomohiro NIIMI, Kariya-shi (JP); Kayoko YUKAWA, Kariya-shi (JP); Kota URABE, Kariya-shi (JP)

(73) Assignee: TOYOTA JIDOSHA KABUSHIKI KAISHA, Toyota-shi (JP)

(21) Appl. No.: 18/758,666

(22) Filed: Jun. 28, 2024

(30) Foreign Application Priority Data
Jul. 28, 2023 (JP) 2023-123392

(51) Int. Cl. H01M 4/36; H01M 4/02; H01M 4/04; H01M 4/38; H01M 10/0525; H01M 10/058

(52) U.S. Cl. CPC H01M 4/364; H01M 4/0404; H01M 4/386; H01M 10/0525; H01M 10/058; H01M 2004/027

(57) ABSTRACT

An electrode composite material in the present disclosure includes a silicon clathrate particle and an amorphous silicon particle, and satisfies the following relational expression: 0 atom %<the number of silicon atoms in the amorphous silicon particle/(the number of silicon atoms in the amorphous silicon particle+the number of silicon atoms in the silicon clathrate particle)<50 atom %. A lithium-ion battery in the present disclosure includes an electrode active material layer, and the electrode active material layer contains the electrode composite material in the present disclosure. Further, a production method for a lithium-ion battery in the present disclosure includes forming an electrode active material layer, and the electrode active material layer contains the electrode composite material in the present disclosure.

### CROSS-REFERENCE TO RELATED APPLICATION

This application claims priority to Japanese Patent Application No. 2023-123392 filed on Jul. 28, 2023, incorporated herein by reference in its entirety.

### BACKGROUND

### 1. Technical Field

The present disclosure relates to an electrode composite material, a lithium-ion battery, and a production method for a lithium-ion battery.

### 2. Description of Related Art

In recent years, the development of batteries has been energetically performed. For example, in the automobile industry, the development of batteries that are used in battery electric vehicles or hybrid electric vehicles has been advanced. Further, silicon is known as an electrode active material that is used in batteries, particularly, lithium-ion batteries.

The silicon electrode active material has a high theoretical capacity, and is effective in increasing the energy density of the battery. On the other hand, the silicon electrode active material has a problem of a large expansion at the time of charging. In response, it is known that the expansion at the time of charging is restrained by using a silicon clathrate electrode active material as the silicon electrode active material.

For example, Japanese Unexamined Patent Application Publication No. 2021-158003 discloses a silicon clathrate electrode active material that has a crystal phase of type II silicon clathrate and has a composition of NaₓSi₁₃₆ (1.98<x<2.54).

### SUMMARY

The silicon clathrate electrode active material makes it possible to restrain the expansion at the time of charging, compared to ordinary silicon electrode active materials. However, it is desired to further restrain the expansion of the silicon clathrate electrode active material at the time of charging.

The present disclosure has an object to provide an electrode composite material that reduces the expansion at the time of charging, a lithium-ion battery that includes the electrode composite material, and a production method for the lithium-ion battery.

The disclosers of the present disclosure have found that the above problem can be solved by the following means.

### <Aspect 1>

An electrode composite material including a silicon clathrate particle and an amorphous silicon particle, the electrode composite material satisfying the following relational expression:

0 atom %<the number of silicon atoms in the amorphous silicon particle/(the number of silicon atoms in the amorphous silicon particle+the number of silicon atoms in the silicon clathrate particle)<50 atom %.

### <Aspect 2>

The electrode composite material according to aspect 1, the electrode composite material satisfying the following relational expression:

0 atom %<the number of silicon atoms in the amorphous silicon particle/(the number of silicon atoms in the amorphous silicon particle+the number of silicon atoms in the silicon clathrate particle)≤30 atom %.

### <Aspect 3>

The electrode composite material according to aspect 1, in which the amorphous silicon particle is a porous amorphous silicon particle.

### <Aspect 4>

A lithium-ion battery including an electrode active material layer, in which
the electrode active material layer contains the electrode composite material according to any one of aspects 1 to 3.

### <Aspect 5>

A production method for a lithium-ion battery, including forming an electrode active material layer, in which
the electrode active material layer contains the electrode composite material according to any one of aspects 1 to 3.

### <Aspect 6>

The method according to aspect 5, including forming the electrode active material layer by a method including:
providing an electrode composite material slurry that contains the electrode composite material according to any one of aspects 1 to 3 and a dispersion medium; and
forming the electrode active material layer by applying the electrode composite material slurry on a base material and removing the dispersion medium by drying.

With the present disclosure, it is possible to provide an electrode composite material that reduces the expansion at the time of charging, a lithium-ion battery that includes the electrode composite material, and a production method for the lithium-ion battery.

### DETAILED DESCRIPTION OF EMBODIMENTS

An embodiment of the present disclosure will be described below in detail. The present disclosure is not limited to the following embodiment, and can be carried out while being variously modified within the scope of the spirit of the present disclosure.

### Electrode Composite Material

An electrode composite material in the present disclosure includes a silicon clathrate particle and an amorphous silicon particle, and satisfies the following relational expression:

0 atom %<the number of silicon atoms in the amorphous silicon particle/(the number of silicon atoms in the amorphous silicon particle+the number of silicon atoms in the silicon clathrate particle)<50 atom %

In a silicon clathrate particle, the change in expansion rate due to charging and discharging is small. However, the sensitivity to non-uniform reaction is high, and the expansion rate increases due to the progress of the non-uniform reaction. In this regard, the disclosers of the present disclosure have thought that the cause for the non-uniform reaction is that the ion conductivity of the silicon clathrate particle is low. Specifically, although the containment by any theory is not intended, it is thought that the reaction is concentrated on the particle surface because the ion conductivity of the silicon clathrate particle is low, and thereby the non-uniform reaction progresses.

In response, the disclosers of the present disclosure have found that it is possible to prevent the progress of the non-uniform reaction in a negative-electrode composite material and thereby restrain the increase in expansion rate when the negative-electrode composite material includes a silicon clathrate particle and an amorphous silicon particle that has a high ion conductivity.

In the present disclosure, “electrode composite material” means a composition matter that can compose an electrode active material layer by itself or by further containing another component. Further, in the present disclosure, “electrode composite material slurry” means a slurry that contains a dispersion medium in addition to the “electrode composite material” and that allows the electrode active material layer to be formed by the applying and drying of the slurry.

Further, in the present disclosure, the “electrode active material” can be used as a “positive-electrode active material” or a “negative-electrode active material”, and particularly, is used as the “negative-electrode active material”.

The electrode composite material in the present disclosure includes a silicon clathrate particle and an amorphous silicon particle.

In the present disclosure, the “silicon clathrate particle” means a silicon particle in which the ratio of silicon clathrate is more than 50 mass %, 60 mass % or more, 70 mass % or more, 80 mass % or more, 90 mass % or more, 95 mass % or more, or 99 mass % or more.

In the present disclosure, the “amorphous silicon particle” means a silicon particle in which the ratio of the amorphous silicon is more than 50 mass %, 60 mass % or more, 70 mass % or more, 80 mass % or more, 90 mass % or more, 95 mass % or more, or 99 mass % or more.

The electrode composite material in the present disclosure satisfies the following relational expression:

0 atom %<the number of silicon atoms in the amorphous silicon particle/(the number of silicon atoms in the amorphous silicon particle+the number of silicon atoms in the silicon clathrate particle)<50 atom %

The number of silicon atoms in the amorphous silicon particle/(the number of silicon atoms in the amorphous silicon particle+the number of silicon atoms in the silicon clathrate particle) may be 1 atom % or more, 2 atom % or more, 3 atom % or more, 4 atom % or more, 5 atom % or more, or 8 atom % or more, and may be 40 atom % or less, 30 atom % or less, 25 atom % or less, 20 atom % or less, 15 atom % or less, or 12 atom % or less, or may be 10 atom %.

As a method for quantitating the silicon clathrate particle and amorphous silicon particle in the electrode composite material, there is a method by a scanning electron microscope (SEM) and electron backscatter diffraction (EBSD). More specifically, the quantitation can be performed by the following method. First, the electrode composite material is buried in a resin, and the resin is cut, so that a cross-section is exposed. Then, to the obtained cross-section, EBSD measurement is performed at such a magnification that the electrode composite material having about five particles is included, for example. Furthermore, the obtained diffraction pattern is analyzed, and a mapping image is obtained by inverse pole figure (IPF) mapping. Thereby, it is possible to quantitate the silicon clathrate particle and amorphous silicon particle in the electrode composite material. The EBSD measurement is a kind of crystal analysis by the scanning electron microscope (SEM), and the following measurement condition can be employed.
Cross-Section Making

Device: CROSS SECTION POLISHER SM-09010 manufactured by JEOL Ltd., Ion Source: argon, Acceleration Voltage: 5.5 kV
SEM

Device: field-emission scanning electron microscope JSM-7000F manufactured by JEOL Ltd., Acceleration Voltage: 7.5 kV
EBSD

Device: OIM crystal orientation analysis device manufactured by TSL Solutions, Acceleration Voltage: 15 kV

In the cross-section making, other than the above-described condition, for example, it is allowable to use a condition of Device: IM-4000 manufactured by Hitachi High-Tech Corporation, Ion Source: Ar, Acceleration Voltage: 5.0 kV.

The ion conductivity of the particle in the electrode composite material may be 0.0655 mS/cm or higher, 0.0660 mS/cm or higher, 0.0665 mS/cm or higher, 0.0670 mS/cm or higher, 0.0675 mS/cm or higher, or 0.0680 mS/cm or higher, and may be 0.0682 mS/cm or lower or 0.0681 mS/cm or lower.

The ion conductivity can be measured by the following method. First, confining pressure is applied to a pellet obtained by pressing the electrode composite material. Then, in a state where the obtained sample is kept at 25° C., the calculation is performed by an alternating-current impedance method. For the measurement, Solartron 1260 of Solartron Analytical can be used. As the measurement condition, the applied voltage can be set to 5 mV, and the measurement frequency range can be set to 0.01 MHz to 1 MHz.

### Silicon Clathrate Particle

The silicon clathrate particle can be prepared by preparing a sodium-silicon (NaSi) alloy and removing sodium from the NaSi alloy.

Specifically, first, the NaSi alloy is prepared by reacting a silicon material and a sodium material such as sodium hydroxide. Thereafter, the NaSi alloy prepared in this way is heated, and sodium is removed from the NaSi alloy for obtaining a clathrate compound, so that the silicon clathrate particle can be prepared. Alternatively, the NaSi alloy prepared in this way and aluminum fluoride as a sodium trap agent are reacted, and sodium is removed from the NaSi alloy for obtaining a clathrate compound, so that the silicon clathrate particle can be prepared.

The silicon clathrate particle may be a porous silicon clathrate particle. The expansion due to charging and discharging can be absorbed by voids of porous silicon clathrate.

The method for producing the porous silicon clathrate particle is, for example, a method including: obtaining a lithium-silicon (LiSi) alloy by mixing silicon and metallic lithium; obtaining porous silicon by reacting the obtained LiSi alloy and ethanol; and obtaining the silicon clathrate particle as described above, using the obtained porous silicon as the silicon material, but is not limited to this.

### Amorphous Silicon Particle

The method for producing the amorphous silicon particle is, for example, a method including: obtaining a lithium-silicon (LiSi) alloy by mixing silicon and metallic lithium; and reacting the obtained LiSi alloy and ethanol, but is not limited to this. By this method, a porous amorphous silicon particle can be obtained.

The electrode composite material in the present disclosure optionally contains a solid electrolyte, a conductive auxiliary agent, and a binder.

### Solid Electrolyte

The material of the solid electrolyte is not particularly limited, and it is possible to use a material that can be used as a solid electrolyte that is used in lithium-ion batteries. For example, the solid electrolyte may be a sulfide solid electrolyte.

Examples of the sulfide solid electrolyte include a sulfide amorphous solid electrolyte, a sulfide crystalloid solid electrolyte, and an argyrodite solid electrolyte, but are not limited to them. Specific examples of the sulfide solid electrolyte include a Li₂S—P₂S₅ series (Li₇P₃S₁₁, Li₃PS₄, Li₈P₂S₉, and the like), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, and the like), LiI—Li₂S—P₂O₅, LiI—Li₃PO₄—P₂S₅, Li₇₋ₓPS₆₋ₓClₓ, and combinations of them, but are not limited to them.

The sulfide solid electrolyte may be glass or crystallized glass (glass ceramic).

### Conductive Auxiliary Agent

The conductive auxiliary agent is not particularly limited. The conductive auxiliary agent may be vapor-grown carbon fiber (VGCF), acetylene black (AB), ketjen black (KB), carbon nanotube (CNT), or carbon nanofiber (CNF), for example, but is not limited to them.

### Binder

The binder is not particularly limited. The binder may be materials such as polyvinylidene fluoride (PVDF), butadiene rubber (BR), and styrene-butadiene rubber (SBR), or combinations of them, for example, but is not limited to them.

### Lithium-Ion Battery

The lithium-ion battery in the present disclosure may be a liquid battery or a solid-state battery. In the present disclosure, the “solid-state battery” means a battery in which at least a solid electrolyte is used as the electrolyte, and accordingly, in the solid-state battery, a combination of a solid electrolyte and a liquid electrolyte may be used as the electrolyte. Further, the solid-state battery in the present disclosure may be an all-solid-state battery, that is, a battery in which only the solid electrolyte is used as the electrolyte.

The lithium-ion battery in the present disclosure can be confined from both sides in the lamination direction of the above layers, by a confining member such as an end plate. The confining method is a method in which the confining torque of a bolt is used, for example, but is not limited to this.

The lithium-ion battery in the present disclosure includes the electrode active material layer, and the electrode active material layer contains the electrode composite material in the present disclosure. Particularly, in the lithium-ion battery in the present disclosure, the electrode composite material may be a negative-electrode composite material, and in this case, the lithium-ion battery in the present disclosure may include a negative-electrode current collector layer, a negative-electrode active material layer containing the electrode composite material in the present disclosure, a solid electrolyte layer, a positive-electrode active material layer, and a positive-electrode current collector layer, in this order. The layers constituting the lithium-ion battery in the case where the electrode composite material in the present disclosure is the negative-electrode composite material will be described below.

### Negative-Electrode Current Collector Layer

The material that is used in the negative-electrode current collector layer is not particularly limited, and materials that can be used as the negative-electrode current collector of the battery can be appropriately employed. The material that is used in the negative-electrode current collector layer may be copper, a copper alloy, or a material in which nickel, chromium, carbon, or the like is plated or deposited on copper, for example, but is not limited to them.

The form of the negative-electrode current collector layer is not particularly limited, and for example, a foil form, a tabular form, a mesh form, or the like can be adopted. Among them, the foil form is preferable.

### Negative-Electrode Active Material Layer

The negative-electrode active material layer contains the electrode composite material in the present disclosure. As for the electrode composite material, it is possible to refer to the above description relevant to the electrode composite material in the present disclosure.

In the case where the negative-electrode active material layer contains a solid electrolyte, the mass ratio (the mass of the electrode active material particle:the mass of the solid electrolyte) between the electrode active material particle and the solid electrolyte in the negative-electrode active material layer preferably should be 85:15 to 30:70, and more preferably should be 80:20 to 40:60.

The thickness of the negative-electrode active material layer may be 0.1 μm to 1000 μm, for example.

### Solid Electrolyte Layer

The solid electrolyte layer includes at least a solid electrolyte. In addition to the solid electrolyte, the solid electrolyte layer may include a binder or the like, as necessary. As for the solid electrolyte and the binder, it is possible to refer to the above description relevant to the electrode composite material in the present disclosure.

The thickness of the solid electrolyte layer is 0.1 μm to 300 μm, for example, and preferably should be 0.1 μm to 100 μm.

### Positive-Electrode Active Material Layer

The positive-electrode active material layer is a layer that contains a positive-electrode active material and optionally contains a solid electrolyte, a conductive auxiliary agent and a binder, and a thickening agent, or the like.

The material of the positive-electrode active material is not particularly limited. The positive-electrode active material may be lithium cobalt oxide (LiCoO₂), lithium nickel oxide (LiNiO₂), lithium manganese oxide (LiMn₂O₄), LiCo_{1/3}Ni_{1/3}Mn_{1/3}O₂, a heterologous element substitution Li—Mn spinel having a composition expressed as Li₁₊ₓMn_{2-x-y}MyO₄ (M is one or more kinds of metal elements selected from Al, Mg, Co, Fe, Ni, and Zn), lithium titanium oxide (LiₓTiO_{y}), lithium metal phosphate (LiMPO₄, M is one or more kinds of metals selected from Fe, Mn, Co, and Ni), or the like, for example, but is not limited to them.

The positive-electrode active material layer may include a covering layer. The covering layer is a layer that has lithium-ion conducting property, that has a low reactivity with the positive-electrode active material and the solid electrolyte, and that contains a substance that does not flow even in the case of the contact with the active material or the solid electrolyte and that allows the shape of the covering layer to be maintained. Specific examples of the material composing the covering layer include LiNbO₃, Li₄Ti₅O₁₂, and Li₃PO₄, but are not limited to them.

Examples of the form of the positive-electrode active material include a particle form. The average particle diameter (D50) of the positive-electrode active material, without being particularly limited, is 10 nm or more, for example, and may be 100 nm or more. Furthermore, the average particle diameter (D50) of the positive-electrode active material is 50 μm or less, for example, and may be 20 μm or less. For example, the average particle diameter (D50) can be calculated based on the measurement with a laser diffraction particle size analyzer or a scanning electron microscope (SEM).

As for the solid electrolyte, the conductive auxiliary agent, and the binder, it is possible to refer to the above description relevant to the electrode composite material in the present disclosure.

In the case where the positive-electrode active material layer contains a solid electrolyte, the mass ratio (the mass of the positive-electrode active material:the mass of the solid electrolyte) between the positive-electrode active material and solid electrolyte in the positive-electrode active material layer preferably should be 85:15 to 30:70, and more preferably should be 80:20 to 50:50.

The thickness of the positive-electrode active material layer is 0.1 μm to 1000 μm, for example, preferably should be 1 μm to 100 μm, and further preferably should be 30 μm to 100 μm.

### Positive-Electrode Current Collector Layer

The material that is used in the positive-electrode current collector layer is not particularly limited, and materials that can be used as the positive-electrode current collector of the battery can be appropriately employed. The material that is used in the positive-electrode current collector layer may be SUS, nickel, chromium, gold, platinum, aluminum, iron, titanium, zinc, or the like, or a material in which nickel, chromium, carbon, or the like is plated or deposited on these metals, for example, but is not limited to them.

The form of the positive-electrode current collector layer is not particularly limited, and for example, a foil form, a tabular form, a mesh form, or the like can be adopted. Among them, the foil form is preferable.

### Production Method for Lithium-Ion Battery

A method for producing the lithium-ion battery in the present disclosure includes forming an electrode active material layer, and the electrode active material layer contains the electrode composite material in the present disclosure.

Examples of the method of forming the electrode active material layer include a method including: providing an electrode composite material slurry that contains the electrode composite material in the present disclosure and a dispersion medium; and forming the electrode active material layer by applying the electrode composite material slurry on a base material and removing the dispersion medium by drying.

For example, in the case where the negative-electrode active material layer contains the electrode composite material in the present disclosure, the method for forming the battery may include forming the negative-electrode active material layer containing the electrode composite material, and in addition, disposing the negative-electrode current collector layer, the negative-electrode active material layer, the electrolyte layer, the positive-electrode active material layer, and the positive-electrode current collector layer, in this order.

### Synthesis Example 1

### Synthesis of Silicon Clathrate Particle

### Alloying Process

A sodium-silicon (NaSi) alloy was produced using Si powder (Kojundo Chemical Laboratory Co., Ltd., SIEPB32) and sodium hydroxide (NaH) as the sodium (Na) material. As the NaH, a material that was previously washed by hexane was used. The NaH and the Si powder were weighed such that the molar ratio was 1.05:1, and the weighed NaH and Si powder were mixed by a cutter mill. The obtained mixture was heated in a heating furnace at 700° C. under an argon atmosphere for 20 hours, so that a powdered NaSi alloy was obtained.

### Clathrate Compound Obtaining Process

The obtained NaSi alloy was heated in the heating furnace at 340° C. under an argon atmosphere, and furthermore was crushed by a ball mill (manufactured by Fritsch), so that a silicon clathrate particle was obtained. The surface of the silicon clathrate particle may include coats and impurities that contain the O-element, the C-element, the N-element, and the like.

### Synthesis Example 2

### Synthesis of Amorphous Silicon Particle

Metallic lithium (Li) and the Si powder were weighed such that the molar ratio was 4:1, and are mixed and reacted in a mortar at room temperature under an argon atmosphere for 0.5 hours. Thereby, Li₄Si was obtained. The obtained Li₄Si was reacted with ethanol under an argon atmosphere. The filtration of the reaction product was performed, and a solid content separated by the filtration was dried at 120° C. for 3 hours or more, so that a powdered porous silicon was obtained. The porous silicon was washed in a 3 wt % hydrogen fluoride (HF) solution, and after filtration, was dried at 120° C. for 3 hours or more, so that an amorphous silicon particle was obtained.

### Comparative Example 1

### Making of Lithium-Ion Battery

### Preparation of Negative-Electrode Composite Material

A 5 wt % butyl butyrate solution containing butyl butyrate and a polyvinylidene fluoride (PVDF) binder, a vapor-grown carbon fiber (VGCF) as a conductive auxiliary agent, the silicon clathrate particle in Synthesis Example 1, and a Li₂S—P₂S₅ glass ceramic as a sulfide solid electrolyte were added in a polypropylene container, and were stirred for 30 seconds by an ultrasonic dispersing device (UH-50 manufactured by SMT Co., Ltd.). Next, the container was shaken for 30 minutes by a shaker (TTM-1 manufactured by Sibata Scientific Technology Ltd.), so that a slurry-formed negative-electrode composite material (negative-electrode composite material slurry) was obtained.

### Formation of Negative-Electrode Active Material Layer

The obtained negative-electrode composite material slurry was applied on a copper (Cu) foil as a negative-electrode current collector layer by a blade method, using an applicator, and was dried on a hot plate heated at 100° C., for 30 minutes, so that a negative-electrode active material layer was formed on the negative-electrode current collector layer.

### Formation of Solid Electrolyte Layer

A 5 wt % heptane solution containing heptane and a butylene rubber (BR) binder, and a Li₂SP₂S₅ glass ceramic as a sulfide solid electrolyte were added in a polypropylene container, and were stirred for 30 seconds by the ultrasonic dispersing device (UH-50 manufactured by SMT Co., Ltd.). Next, the container was shaken for 30 minutes by the shaker (TTM-1 manufactured by Sibata Scientific Technology Ltd.), so that a solid electrolyte slurry was obtained.

The obtained solid electrolyte slurry was applied on an aluminum (Al) foil as a release sheet by the blade method, using the applicator, and was dried on the hot plate heated at 100° C., for 30 minutes, so that a solid electrolyte layer was formed. A plurality of solid electrolyte layers was made.

### Preparation of Positive-Electrode Composite Material

A 5 wt % butyl butyrate solution containing butyl butyrate and a PVDF binder, LiNi_{1/3}Co_{1/3}Mn_{1/3}O₂ with an average particle diameter of 6 μm as a positive-electrode active material, a Li₂S—P₂S₅ glass ceramic as a sulfide solid electrolyte, and VGCF as a conductive auxiliary agent were added in a polypropylene container, and were stirred for 30 seconds by the ultrasonic dispersing device (UH-50 manufactured by SMT Co., Ltd.). Next, the container was shaken for 3 minutes by the shaker (TTM-1 manufactured by Sibata Scientific Technology Ltd.). Furthermore, the container was stirred for 30 seconds by the ultrasonic dispersing device, and was shaken for 3 minutes by the shaker, so that a slurry-formed positive-electrode composite material (positive-electrode composite material slurry) was obtained.

### Formation of Positive-Electrode Active Material Layer

The obtained positive-electrode composite material slurry was applied on an Al foil as a positive-electrode current collector layer by the blade method, using the applicator, and was dried on the hot plate heated at 100° C., for 30 minutes, so that a positive-electrode active material layer was formed on the positive-electrode current collector layer.

### Assembly of Battery

The positive-electrode current collector layer, the positive-electrode active material layer, and the first solid electrolyte layer were laminated in this order. This laminate was set in a roll press machine, and was pressed at a press pressure of 100 kN/cm and a press temperature of 165° C., so that a positive-electrode laminated body was obtained.

The negative-electrode current collector layer, the negative-electrode active material layer, and the second solid electrolyte layer were laminated in this order. This laminate was set in the roll press machine, and was pressed at a press pressure of 60 kN/cm and a press temperature of 25° C., so that a negative-electrode laminated body was obtained.

Furthermore, the Al foils as the release sheets were released from solid electrolyte layer surfaces of the positive-electrode laminated body and the negative-electrode laminated body. Next, the Al foil as the release sheet was released from the third solid electrolyte layer.

The positive-electrode laminated body, the negative-electrode laminated body, and the third solid electrolyte layer were laminated such that the respective solid electrolyte layer sides of the positive-electrode laminated body and the negative-electrode laminated body face the third solid electrolyte layer. This laminated body was set in a planar uniaxial press machine, and was temporarily pressed at 100 MPa and 25° C. for 10 seconds. Finally, this laminated body was set in the planar uniaxial press machine, and was pressed at a press pressure of 200 MPa and a press temperature of 120° C. for 1 minute. Thereby, an all-solid-state battery in Comparative Example 1 was obtained.

### Comparative Examples 2 to 4 and Examples 1 to 3

All-solid-state batteries in Comparative Examples 2 to 4 and Examples 1 to 3 were obtained similarly to those in Comparative Example 1, except that the silicon clathrate particle in Synthesis Example 1 and the amorphous silicon particle in Synthesis Example 2 were at silicon atom number ratios described in Table 1, in the preparation of the negative-electrode composite material.

### Evaluation

### Quantitation of Each Silicon Particle in Electrode Composite Material

The silicon clathrate particle and amorphous silicon particle in the electrode composite material were quantitated by the scanning electron microscope (SEM) and the electron backscatter diffraction (EBSD). More specifically, the quantitation was performed by the following method. First, the electrode composite material was buried in a resin, and the resin was cut, so that a cross-section was exposed. Then, to the obtained cross-section, EBSD measurement was performed at such a magnification that the electrode composite material having about five particles was included. Furthermore, the obtained diffraction pattern was analyzed, and a mapping image was obtained by inverse pole figure (IPF) mapping. Thereby, the silicon clathrate particle and amorphous silicon particle in the electrode composite material were quantitated. The following measurement condition was employed.
Cross-Section Making

Device: CROSS SECTION POLISHER SM-09010 manufactured by JEOL Ltd., Ion Source: argon, Acceleration Voltage: 5.5 kV
SEM

Device: field-emission scanning electron microscope JSM-7000F manufactured by JEOL Ltd., Acceleration Voltage: 7.5 kV
EBSD

Device: OIM crystal orientation analysis device manufactured by TSL Solutions, Acceleration Voltage: 15 kV

### Measurement of Ion Conductivity

The ion conductivity of the particle in the electrode composite material was measured by the following method. First, confining pressure was applied to a pellet obtained by pressing the electrode active material particle. Then, in a state where the obtained sample was kept at 25° C., the calculation was performed by the alternating-current impedance method. For the measurement, Solartron 1260 of Solartron Analytical was used. As the measurement condition, the applied voltage was 5 mV, and the measurement frequency range was set to 0.01 MHz to 1 MHz.

### Measurement of Confining Pressure Increase Amount

The made cell was confined at a predetermined confining pressure using a confining jig, and the confining pressure increase amount when charging at a constant current and a constant voltage was performed to 4.55 V at 10 hour rate (1/10 C) was measured. A large confining pressure increase amount means that the expansion amount of the active material is large. The confining pressure increase amount is the difference between the highest value and lowest value of the confining pressure, and the values in the examples are shown as relative values when the value in Comparative Example 1 is 100.

### Result

Table 1 shows the ratio of the number of silicon atoms in each silicon particle, the ion conductivity of the particle in the electrode composite material, and the measurement result of the confining pressure increase amount of the battery.

TABLE 1

| | Ratio of Si Atom Number | | | |
|---|---|---|---|---|
| | [atom %] | | | Confining |
| | Si | Amorphous | Ion | Pressure |
| | Clathrate | Si | Conductivity | Increase |
| | Particle | Particle | [mS/cm] | Amount |
| Comparative | 100 | 0 | 0.0511 | 100 |
| Example 1 | | | | |
| Comparative | 0 | 100 | 0.0798 | 110 |
| Example 2 | | | | |
| Comparative | 50 | 50 | 0.0654 | 105 |
| Example 3 | | | | |
| Comparative | 20 | 80 | 0.0683 | 108 |
| Example 4 | | | | |
| Example 1 | 80 | 20 | 0.0660 | 97 |
| Example 2 | 90 | 10 | 0.0681 | 89 |
| Example 3 | 95 | 5 | 0.0661 | 96 |

As shown in Table 1, in the batteries in the examples that included the electrode composite material in the present disclosure, the confining pressure increase amount was smaller than in the batteries in the comparative examples. The reason is thought to be that the ion conductivity was high because the electrode composite material in the present disclosure included the silicon clathrate particle having a high effect for expansion rate restraint and included the amorphous silicon particle within the range in the present disclosure.

What is claimed is:

1. An electrode composite material including a silicon clathrate particle and an amorphous silicon particle, the electrode composite material satisfying a following relational expression:
0 atom %<the number of silicon atoms in the amorphous silicon particle/(the number of silicon atoms in the amorphous silicon particle+the number of silicon atoms in the silicon clathrate particle)<50 atom %.

2. The electrode composite material according to claim 1, the electrode composite material satisfying a following relational expression:
0 atom %<the number of silicon atoms in the amorphous silicon particle/(the number of silicon atoms in the amorphous silicon particle+the number of silicon atoms in the silicon clathrate particle)≤30 atom %.

3. The electrode composite material according to claim 1, wherein the amorphous silicon particle is a porous amorphous silicon particle.

4. A lithium-ion battery comprising an electrode active material layer, wherein
the electrode active material layer contains the electrode composite material according to claim 1.

5. A production method for a lithium-ion battery, comprising forming an electrode active material layer, wherein
the electrode active material layer contains the electrode composite material according to claim 1.

6. A method comprising forming an electrode active material layer by a method including:
providing an electrode composite material slurry that contains the electrode composite material according to claim 1 and a dispersion medium; and
forming the electrode active material layer by applying the electrode composite material slurry on a base material and removing the dispersion medium by drying.
